(19) United States
(12) Patent Application Publication
(10) Pub. No.: US 2021/0117895 A1
(43) Pub. Date: Apr. 22, 2021

(54) Systems and Methods for Cross-Platform Scheduling and Workload Automation

(71) Applicant: ASG Technologies Group, Inc. dba ASG Technologies, Naples, FL (US)

(72) Inventors: Barrie R. Tondevold, West Jordan, UT (US); David S. Young, South Jordan, UT (US)

(21) Appl. No.: 16/796,451

(22) Filed: Feb. 20, 2020

Related U.S. Application Data
(60) Provisional application No. 62/923,164, filed on Oct. 18, 2019.

(51) Int. Cl. G06Q 10/06; G06Q 10/10; G06F 21/41

(52) U.S. Cl. CPC G06Q 10/06316; G06F 21/41; G06Q 10/103; G06Q 10/0633

(57) ABSTRACT

Various embodiments of the present technology are directed to methods for workload management and automation. In some embodiments the methods include (A) executing a workflow using a request/response API, the workflow design-time comprising: (i) defining a task and process and run-time requirements of the workflow; (ii) assembling and sequencing of the work into a workflow; (iii) defining execution affinities, dependencies, and completion criteria of the workflow; and (iv) scheduling the workflow; (B) executing a workflow run-time, the workflow run-time comprising: (i) receiving a request for the work using the request/response API; (ii) executing the workflow using the workflow design-time and the request/response API; and (iii) sending a response after the executing of the workflow using the request/response API.

### CROSS-REFERENCE TO RELATED APPLICATIONS

This patent application claims the benefit and priority of U.S. Provisional Patent Application No. 62/923,164 filed on Oct. 18, 2019, entitled “Systems and Methods for a Workload Management Service,” which is incorporated herein by reference in its entirety for all purposes.

### FIELD OF THE TECHNOLOGY

Embodiments of the disclosure relate to a processing framework for workload management and automation. In particular, the present disclosure relates to systems and methods for a processing framework which allows a new or an existing computer system to communicate with disparate systems for workload management and automation.

### BACKGROUND

The approaches described in this section could be pursued but are not necessarily approaches that have previously been conceived or pursued. Therefore, unless otherwise indicated, it should not be assumed that any of the approaches described in this section qualify as prior art merely by virtue of their inclusion in this section.

As enterprises move to continuous business application deployment, the need for a multi-purpose life-cycle automation platform has never been greater. In other words, the need is great for a flexible, digital automation platform for abstracting business application processes into automation rules. Thus, from digital natives to mainframe operations, whether developers, operations or combining software development (DEV) and information-technology operations (OPS) (i.e., DEVOPS), there is a need for a workload management service for defining the rules, sequencing the actions, and handling the exceptions.

### SUMMARY

In some embodiments, the present disclosure is directed to a system of one or more computers which can be configured to perform particular operations or actions by virtue of having software, firmware, hardware, or a combination thereof installed on the system that in operation causes or cause the system to perform actions and/or method steps as described herein. For example, embodiments of the present technology are directed to methods for workload management and automation. In various embodiments the methods include (A) executing a workflow using a request/response API, the workflow design-time comprising: (i) defining a task and process and run-time requirements of the workflow; (ii) assembling and sequencing of the work into a workflow; (iii) defining execution affinities, dependencies, and completion criteria of the workflow; and (iv) scheduling the workflow; (B) executing a workflow run-time, the workflow run-time comprising: (i) receiving a request for the work using the request/response API; (ii) executing the workflow using the workflow design-time and the request/response API; and (iii) sending a response after the executing of the workflow using the request/response API.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

FIG. 1 illustrates an environment within which methods and systems for cross-platform scheduling and workload automation using a workflow automation module, according to exemplary embodiments of the present technology.

FIG. 2 is a block diagram of a workflow automation module for cross-platform scheduling and workload automation, according to exemplary embodiments of the present technology.

FIG. 3 illustrates a block diagram of interfacing with a wide array of computer systems for cross-platform scheduling and workload automation, according to embodiments of the present technology.

FIG. 4 depicts a flow chart for an input request for cross-platform scheduling and workload automation, according to embodiments of the present technology.

FIG. 5 illustrates an exemplary computer system that may be used to implement cross-platform scheduling and workload automation, according to exemplary embodiments of the present technology.

### DETAILED DESCRIPTION

In the following description, for purposes of explanation, numerous specific details are set forth in order to provide a thorough understanding of the disclosure. It will be apparent, however, to one skilled in the art, that the disclosure may be practiced without these specific details. In other instances, structures and devices may be shown in block diagram form only in order to avoid obscuring the disclosure. It should be understood that the disclosed embodiments are merely exemplary of the invention, which may be embodied in multiple forms. Those details disclosed herein are not to be interpreted in any form as limiting, but as the basis for the claims.

In various embodiments the present technology provides robust scheduling and automation for physical, virtual, and hybrid environments. For instance, embodiments are a robust, workload automation solution for multi-platform environments that support event-based scheduling as well as traditional date-and time-based schedules. The present technology provides exception-based management, a highly scalable architecture, high availability, and role-based security. The present technology enables the management of workloads across multiple operating systems (OSs) including Windows®, UNIX®, Linux®, AS/400, and z/OS in both physical, virtual, and cloud environments. The present technology further provides a cluster-based fault tolerance model that allows a workload to be executed on multiple backup servers in a fail-over scenario.

In various embodiments the present technology features an easy-to-use workflow diagram for both production and application development to effectively automate and integrate workload and business processes. Embodiments allow enterprises to solve business problems while bridging departmental boundaries and offering scalability and integration capabilities. Various embodiments offer scheduling and script-less integration capabilities for technologies such as Microsoft® .net and J2EE environments. Embodiments of the present technology offer security and data redundancy capabilities and support growing audit support requirements of the enterprise with centralized logging, archiving, rollback, and custom reporting capabilities. Embodiments of the present technology enable cross-platform triggering capabilities with centralized coordination of multiple server environments whether physical or virtual. Embodiments further extend workload management capabilities across the entire enterprise and provide capabilities such as enterprise flowcharting and critical path management.

Various embodiments of the present technology provide flexible workload automation and feature a graphical process whiteboard for task definition. For instance, component-based architecture of the present technology minimizes redundant definitions and maximizes flexibility. For example, tasks may be defined to run on a specific machine or a logical set of machines using workload-balancing capabilities, thus, maximizing machine resources. In various embodiments reusable templates and variables at the task, process, or system level simplify definitions and streamline data flow.

Embodiments of the present technology provide broad and flexible integration with other technologies. For example, embodiments integrate application development and server environments, such as Web services, .net, and J2EE, as well as other technologies such as FTP, HTTP, SMTP, ADO, and the like. Integration functionality of the present technology eliminates the manual scripting of integration of existing applications with newer technologies and greatly reduces overall costs. The present technology of an advanced agent enables workload management on multiple platforms is some instances. Trigger-based processes can find new files within a directory, receive a message within MSMQ or JMS message queues, detect a change to a file within a directory, or even detect an event log addition in some embodiments.

Various embodiments of the present technology provide a centralized console and workbench for an operator. Embodiments enable management of distributed scheduling through a centralized console with dashboard capabilities including predefined as well as user-customizable views and reports to meet needs of individual users. Embodiments integrate with third party tools and applications to protect Information Technology (IT) investment and provide a user with a one-stop snapshot of real-time workload of the enterprise and automation status and progress.

In various embodiments the present technology provides methods to run programs on external computer systems by allowing remote calling and sending back well-formed responses received from the computer hosts that process requests.

Some embodiments of the present technology include a program providing the ability to incorporate workflow automation into new and/or existing computer programs via a comprehensive set of services, and providing out of the box scheduling access to various other software systems, Operating Systems (OSs), Enterprise Resource Planning (ERP), Managed File Transfer (MFT), and Database systems. Embodiments of the present technology include execution of on-demand computer system resources capable of receiving requests in addition to any parameters required for executing a computer resource. For example, a programmed script allowing selection of a prospective schedule for executing a computer program. Furthermore, determining a response for the request as well as sending back results of program processing by invoking other computer programs designed to handle response data becoming available after processing.

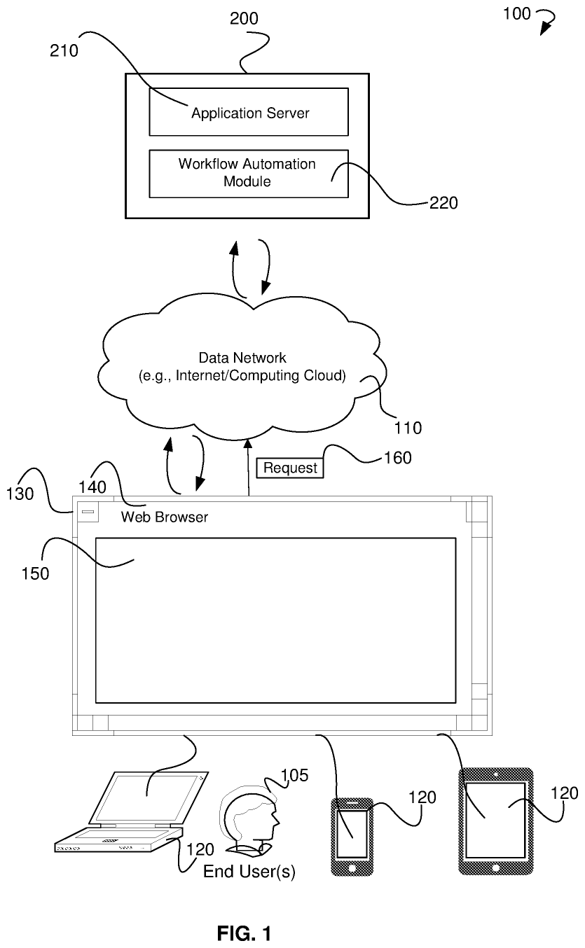

Referring now to the drawings, FIG. 1 illustrates an environment 100 within which methods and systems for cross-platform scheduling and workload automation using a workflow automation module, according to exemplary embodiments of the present technology. FIG. 1 illustrates the environment 100 within which systems and methods for cross-platform scheduling and workload automation using a workflow automation module can be implemented. The environment 100 may include a data network 110 (e.g., an Internet or a computing cloud), end user(s) 105, client device(s) 120 associated with the end user 105, and a system 200 for cross-platform scheduling and workload automation using a workflow automation module. In some embodiments, end user(s) 105 may comprise IT developers who are individuals that build and create software applications and are proficient in one or more coding languages, citizen developers who are developers that are part of a customer team who may not be as technology savvy as an IT developer, and business analysts who hold the knowledge of their application but typically are not technical people. Client device(s) 120 may comprise a personal computer (PC), a desktop computer, a laptop, a smartphone, a tablet, or so forth.

The system 200 may include an application server 210 and a workflow automation module 220. The client device 120 may have a user interface 130. Furthermore, a web browser 140 may be running on the client device 120 and may be displayed using the user interface 130. The web browser 140 may communicate with the application server 210 via the data network 110.

The data network 110 may include the Internet or any other network capable of communicating data between devices. Suitable networks may include or interface with any one or more of, for instance, a local intranet, a corporate data network, a data center network, a home data network, a Personal Area Network, a Local Area Network (LAN), a Wide Area Network (WAN), a Metropolitan Area Network, a virtual private network, a storage area network, a frame relay connection, an Advanced Intelligent Network connection, a synchronous optical network connection, a digital T1, T3, E1 or E3 line, Digital Data Service connection, Digital Subscriber Line connection, an Ethernet connection, an Integrated Services Digital Network line, a dial-up port such as a V.90, V.34 or V.34bis analog modem connection, a cable modem, an Asynchronous Transfer Mode connection, or a Fiber Distributed Data Interface or Copper Distributed Data Interface connection. Furthermore, communications may also include links to any of a variety of wireless networks, including Wireless Application Protocol, General Packet Radio Service, Global System for Mobile Communication, Code Division Multiple Access or Time Division Multiple Access, cellular phone networks, Global Positioning System, cellular digital packet data, Research in Motion, Limited duplex paging network, Bluetooth radio, or an IEEE 802.11-based radio frequency network. The data network can further include or interface with any one or more of a Recommended Standard 232 (RS-232) serial connection, an IEEE-1394 (FireWire) connection, a Fiber Channel connection, an IrDA (infrared) port, a Small Computer Systems Interface connection, a Universal Serial Bus (USB) connection or other wired or wireless, digital or analog interface or connection, mesh or Digi® networking.

The web browser 140 may display a web page associated with a studio 150 where end user(s) 105 can build applications using different products. The web browser 140 may establish a communication channel with the application server 210 and may generate and render virtual screens based on data received from the application server 210.

The end user 105 may send a request 160 to the system 200 using the client device 120. The request 160 may include a request to deploy a component to an application. In response to the request 160, the application server 210 may load the component to the application. The application and the component may be rendered by the web browser 140.

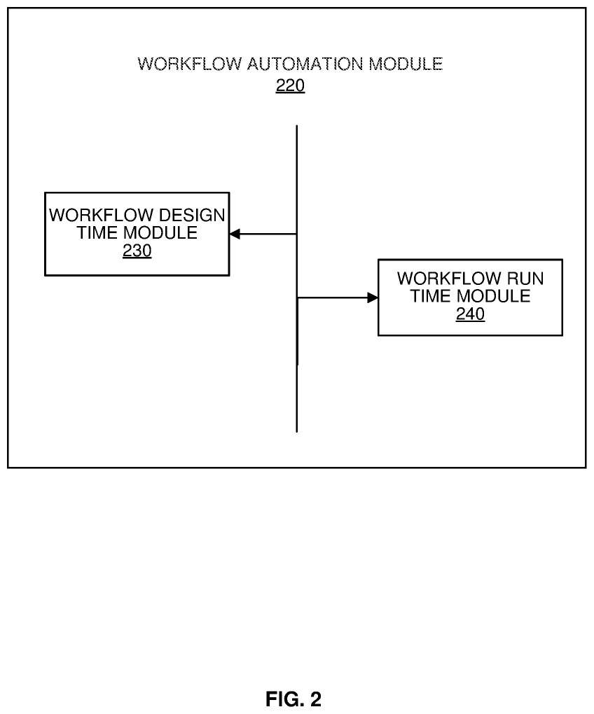

FIG. 2 is a block diagram of a workflow automation module 220 for cross-platform scheduling and workload automation, according to exemplary embodiments of the present technology. FIG. 2 shows a block diagram illustrating various modules of the workflow automation module 220, according to example embodiments. The workflow automation module 220 may include a workflow design time module 230 that provides a framework to design workflows and a workflow runtime module 240 that allows the workflows created in the workflow design time module 230 to be executed or deployed in runtime.

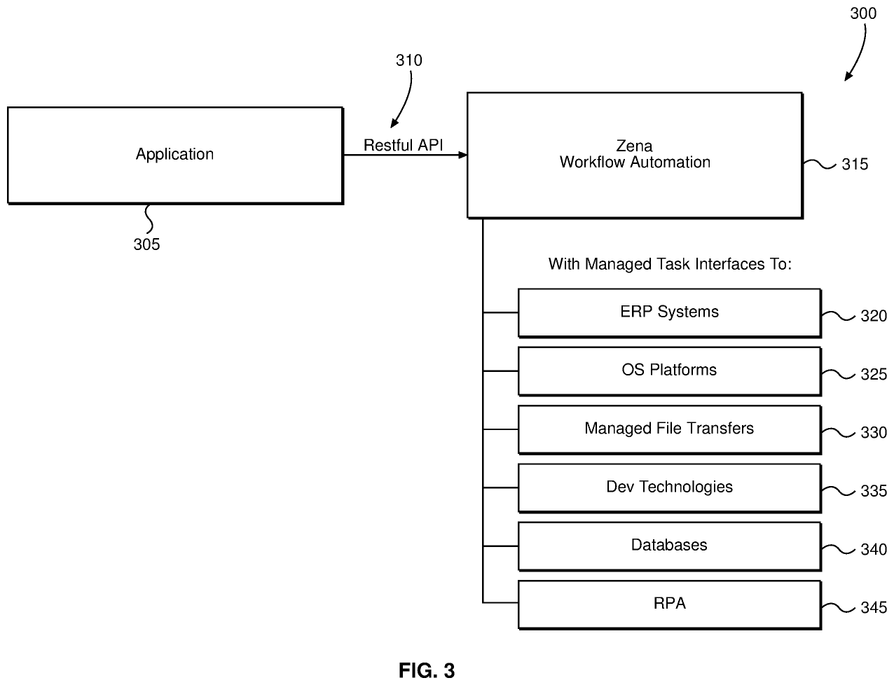

FIG. 3 illustrates a block diagram 300 of interfacing with a wide array of computer systems for cross-platform scheduling and workload automation, according to embodiments of the present technology. The block diagram 300 of FIG. 3 illustrates an application interfacing with workflow automation via a Representational State Transfer (REST) Application Programing Interface (API). The REST software defines a set of rules to be used for creating web services and web services which follow the REST may be referred to as RESTful web services. The REST API allows requesting systems to access and manipulate web resources by using a uniform and predefined set of rules. In various embodiments integration is with other APIs including NET (Assembly), COM, Java, Windows PowerShell, and the like. The workflow automation comprises managed task interfaces to Enterprise Resource Planning (ERP) systems, Operating System (OS) platforms (Windows®, UNIX, Linux, IBM i, z/OS, and the like), Managed File Transfer (MFT), development technologies, database systems (Oracle, MSSQL, JDBC compliant databases, and the like), and Robotic Process Automation (RPA). For example, RPA allows a user to configure computer software to emulate and integrate the actions of a human interacting within digital systems to execute a business process. Embodiments for cross-platform scheduling and workload automation include integration with various application environments including SAP, Oracle, PeopleSoft, Micro Focus Server, J2EE Application Servers, Drop Box, Google Drive, OneDrive, Hadoop, Open Amazon S3 Operation, MSSQL Job Scheduler, SSIS, and the like. Protocols used for integration include FTP, FTP/s, SFTP, HTTP, SMTP, SNMP, SSH, AES encryption between the server and agents, and the like.

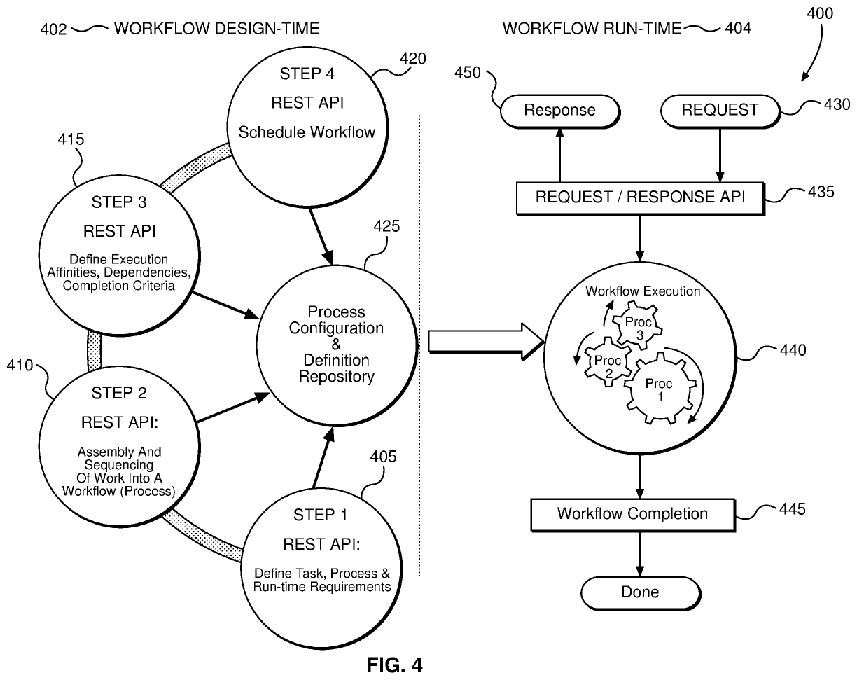

FIG. 4 depicts a flow chart 400 for an input request according to embodiments of the present technology. The flow chart 400 of FIG. 4 depicts workflow design-time and workflow run-time in various embodiments.

In some embodiments workflow design-time comprises steps 1 through 4. Step 1 includes defining a task and process and run-time requirements, via a REST API. Step 2 includes assembling and sequencing of work into a workflow via a REST API. Step 3 includes defining execution affinities, dependencies, and completion criteria via a REST API. Step 4 includes scheduling a workflow via a REST API. Finally, the flow chart 400 shows that workflow design-time steps 1 through 4 are for processing configuration and definition repository that feed into workflow execution of the workflow run-time.

In various embodiments workflow run-time comprises receiving a request and sending a response via a request/response API. Using a request/response API execution of the request by the workflow execution is completed. After workflow completion, a response may be sent via the request/response API indicating workflow completion.

In various embodiments the present technology includes auditing and reporting on all operations, notifications on abnormal conditions and results, automated reruns to improve uptime, server redundancy check, support for IT-managed corporate SQL and Oracle databases, storing and forwarding messages when disparate systems are involved, and various event monitors to facilitate automation.

In various embodiments of the present technology provides a workload management and automation service that is a robust, enterprise-wide workload management solution for distributed operations environments that support “event-based” scheduling as well as traditional time and date-based scheduling methodologies. For example, the present technology may be the workload management and automation service between RPA for Business Process Management (BPM) and RPA for an automated task (also referred herein to as a bot) engine technology.

In various embodiments of the present technology facilitates end-to-end, integrated workload management across multiple operating environments and allows scalability and integration capabilities to execute hundreds of thousands of workloads. Embodiments provide fault tolerance with active redundancy and extend centralized management to business application environments such as SAP, PeopleSoft and Oracle, and the like.

Embodiments of the present technology enable script-less integration and automation across multiple environments such as J2EE, .NET and Web services and allow a centralized console to manage multiple server environments. Furthermore, embodiments provide exception management with extensive alert and proactive component monitoring and notification capabilities and enhance flexibility with customizable views and reporting while automating corrective actions. Moreover, embodiments allow IT process automation capabilities enabled through extensive integration facilities and a robust graphical interface.

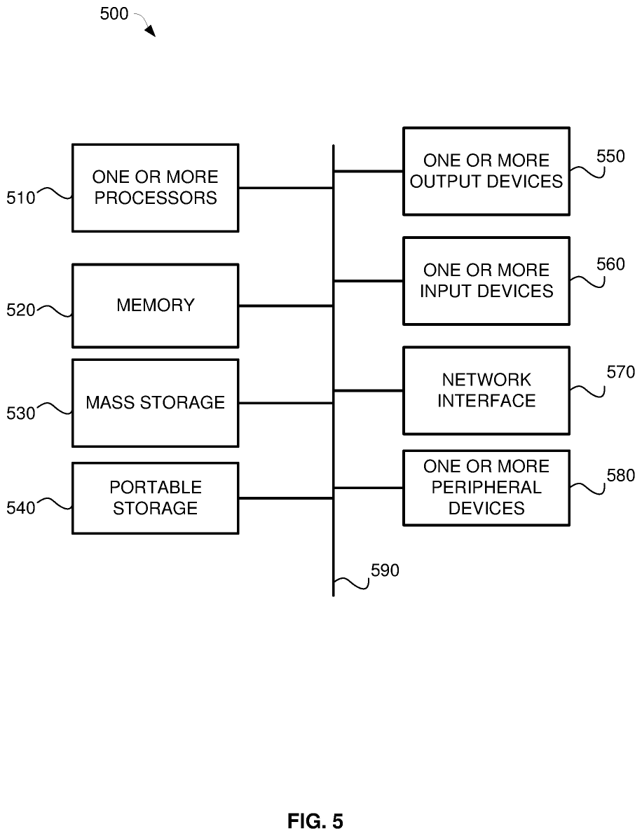

FIG. 5 illustrates an exemplary computing system 500 that may be used to implement embodiments described herein. The exemplary computing system 500 of FIG. 5 may include one or more processors 510 and memory 520. Memory 520 may store, in part, instructions and data for execution by the one or more processors 510. Memory 520 can store the executable code when the exemplary computing 500 is in operation. The exemplary computing system 500 of FIG. 5 may further include a mass storage 530, portable storage 540, one or more output devices 550, one or more input devices 560, a network interface 570, and one or more peripheral devices 580.

The components shown in FIG. 5 are depicted as being connected via a single bus 590. The components may be connected through one or more data transport means. The one or more processors 510 and memory 520 may be connected via a local microprocessor bus, and the mass storage 530, one or more peripheral devices 580, portable storage 540, and network interface 570 may be connected via one or more input/output buses.

Mass storage 530, which may be implemented with a magnetic disk drive or an optical disk drive, is a non-volatile storage device for storing data and instructions for use by a magnetic disk or an optical disk drive, which in turn may be used by one or more processors 510. Mass storage 530 can store the system software for implementing embodiments described herein for purposes of loading that software into memory 520.

Portable storage 540 may operate in conjunction with a portable non-volatile storage medium, such as a compact disk (CD) or digital video disc (DVD), to input and output data and code to and from the computing system 500 of FIG. 5. The system software for implementing embodiments described herein may be stored on such a portable medium and input to the computing system 500 via the portable storage 540.

One or more input devices 560 provide a portion of a user interface. The one or more input devices 560 may include an alphanumeric keypad, such as a keyboard, for inputting alphanumeric and other information, or a pointing device, such as a mouse, a trackball, a stylus, or cursor direction keys. Additionally, the computing system 500 as shown in FIG. 5 includes one or more output devices 550. Suitable one or more output devices 550 include speakers, printers, network interfaces, and monitors.

Network interface 570 can be utilized to communicate with external devices, external computing devices, servers, and networked systems via one or more communications networks such as one or more wired, wireless, or optical networks including, for example, the Internet, intranet, LAN, WAN, cellular phone networks (e.g., Global System for Mobile communications network, packet switching communications network, circuit switching communications network), Bluetooth radio, and an IEEE 802.11-based radio frequency network, among others. Network interface 570 may be a network interface card, such as an Ethernet card, optical transceiver, radio frequency transceiver, or any other type of device that can send and receive information. Other examples of such network interfaces may include Bluetooth®, 3G, 4G, and WiFi® radios in mobile computing devices as well as a USB.

One or more peripheral devices 580 may include any type of computer support device to add additional functionality to the computing system. The one or more peripheral devices 580 may include a modem or a router.

The components contained in the exemplary computing system 500 of FIG. 5 are those typically found in computing systems that may be suitable for use with embodiments described herein and are intended to represent a broad category of such computer components that are well known in the art. Thus, the exemplary computing system 500 of FIG. 5 can be a personal computer, handheld computing device, telephone, mobile computing device, workstation, server, minicomputer, mainframe computer, or any other computing device. The computer can also include different bus configurations, networked platforms, multi-processor platforms, and so forth. Various operating systems (OS) can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the example embodiments. Those skilled in the art are familiar with instructions, processor(s), and storage media.

It is noteworthy that any hardware platform suitable for performing the processing described herein is suitable for use with the example embodiments. The terms “computer-readable storage medium” and “computer-readable storage media” as used herein refer to any medium or media that participate in providing instructions to a central processing unit (CPU) for execution. Such media can take many forms, including, but not limited to, non-volatile media, volatile media, and transmission media. Non-volatile media include, for example, optical or magnetic disks, such as a fixed disk. Volatile media include dynamic memory, such as RAM. Transmission media include coaxial cables, copper wire, and fiber optics, among others, including the wires that include one embodiment of a bus. Transmission media can also take the form of acoustic or light waves, such as those generated during radio frequency and infrared data communications. Common forms of computer-readable media include, for example, a floppy disk, a flexible disk, a hard disk, magnetic tape, any other magnetic medium, a CD-read-only memory (ROM) disk, DVD, any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Thus, various embodiments of methods and systems for enabling seamless integration between multiple products as a common layer by using a common visual modeler have been described. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense. There are many alternative ways of implementing the present technology. The disclosed examples are illustrative and not restrictive.

What is claimed is:

1. A method for a workload management and automation service between Robotic Process Automation (RPA) for Business Process Management (BPM) and RPA bot engine technology, the method comprising:
executing a workflow design-time using a Representational State Transfer (REST) Application Programing Interface (API), the workflow design-time comprising:
defining a task, process, and run-time requirements of work;
assembling and sequencing of the work into a workflow based on the task, process, and run-time requirements;
defining execution affinities, dependencies, and completion criteria of the workflow; and
scheduling the workflow based on the execution affinities, the dependencies, and the completion criteria of the workflow;
executing a workflow run-time using a request/response API, the workflow run-time comprising:
receiving a request for the work;
executing the workflow based on the request for the work using the workflow design-time; and
sending a response to the request for the work after the executing the workflow using the request/response API.

2. The method of claim 1, wherein the workflow design-time further comprises:
receiving, from a user, updated completion criteria of the workflow; and
updating the scheduling the workflow using the updated completion criteria of the workflow.

3. The method of claim 1, wherein the workflow run-time further comprises:
receiving a priority request for the work; and
executing the workflow based on the priority request for the work.

4. The method of claim 1, wherein the workflow design-time further comprises:
sending, to a user, the scheduling of the workflow based on the execution affinities, the dependencies, and the completion criteria of the workflow;
receiving feedback based on the sending the scheduling of the workflow; and
updating the scheduling the workflow using the feedback.

5. The method of claim 1, wherein the workflow run-time further comprises: receiving a return response based on the sending the response to the request for the work, the return response including response data.

6. The method of claim 5, wherein the response data the return response comprises specific parameters required for the workflow design-time for executing a computer resource.

7. The method of claim 6, wherein the workflow design-time further comprises:
updating the scheduling the workflow based on the specific parameters required for the workflow design-time, the specific parameters required for the workflow design-time being used as an input for the workflow design-time.

8. The method of claim 1, further comprising displaying the executing the workflow design-time and the executing the workflow run-time in real-time via a single graphical user interface.

9. The method of claim 8, further comprising:
receiving user credentials from a user; and
based on the user credentials, authenticating the user for both the workflow design-time and the workflow run-time, wherein the user accesses both the workflow design-time and the workflow run-time via the single graphical user interface.

10. A system for a workload management and automation service between Robotic Process Automation (RPA) for Business Process Management (BPM) and RPA bot engine technology, the system comprising:
at least one server, the at least one server comprising at least one processor; and
a memory storing processor-executable instructions, wherein the at least one processor is configured to implement the following operations upon executing the processor-executable instructions:
executing a workflow design-time using a Representational State Transfer (REST) Application Programing Interface (API), the workflow design-time comprising:
defining a task, process, and run-time requirements of work;
assembling and sequencing of the work into a workflow based on the task, process, and run-time requirements;
defining execution affinities, dependencies, and completion criteria of the workflow; and
scheduling the workflow based on the execution affinities, the dependencies, and the completion criteria of the workflow;
executing a workflow run-time using a request/response API, the workflow run-time comprising:
receiving a request for the work;
executing the workflow based on the request for the work using the workflow design-time; and
sending a response to the request for the work after the executing the workflow using the request/response API.

11. The system of claim 10, wherein the workflow design-time further comprises:
receiving, from a user, updated completion criteria of the workflow; and
updating the scheduling the workflow using the updated completion criteria of the workflow.

12. The system of claim 10, wherein the workflow run-time further comprises:
receiving a priority request for the work; and
executing the workflow based on the priority request for the work.

13. The system of claim 10, wherein the workflow design-time further comprises:
sending, to a user, the scheduling of the workflow based on the execution affinities, the dependencies, and the completion criteria of the workflow;
receiving feedback based on the sending the scheduling of the workflow; and
updating the scheduling the workflow using the feedback.

14. The system of claim 10, wherein the workflow run-time further comprises: receiving a return response based on the sending the response to the request for the work, the return response including response data.

15. The system of claim 14, wherein the response data the return response comprises specific parameters required for the workflow design-time for executing a computer resource.

16. The system of claim 15, wherein the workflow design-time further comprises:
updating the scheduling the workflow based on the specific parameters required for the workflow design-time, the specific parameters required for the workflow design-time being used as an input for the workflow design-time.

17. The system of claim 10, wherein the operations further comprise:
displaying the executing the workflow design-time and the executing the workflow run-time in real-time via a single graphical user interface.

18. The system of claim 17, wherein the operations further comprise:
authenticating a user using credentials received from the user for both the workflow design-time and the workflow run-time, wherein the user accesses both the workflow design-time and the workflow run-time via the single graphical user interface.

19. A system for a workload management and automation service between Robotic Process Automation (RPA) for Business Process Management (BPM) and RPA bot engine technology, the system comprising:
at least one server, the at least one server comprising at least one processor; and
a memory storing processor-executable instructions, wherein the at least one processor is configured to implement the following operations upon executing the processor-executable instructions:
executing a workflow design-time using a Representational State Transfer (REST) Application Programing Interface (API), the workflow design-time comprising:
defining a task, process, and run-time requirements of work;
assembling and sequencing of the work into a workflow based on the task, process, and run-time requirements;
defining execution affinities, dependencies, and completion criteria of the workflow; and
scheduling the workflow based on the execution affinities, the dependencies, and the completion criteria of the workflow;
executing a workflow run-time using a request/response API, the workflow run-time comprising:
receiving a request for the work;
executing the workflow based on the request for the work using the workflow design-time; and
sending a response to the request for the work after the executing the workflow using the request/response API; and
displaying the executing the workflow design-time and the executing the workflow run-time in real-time via a single graphical user interface.

20. The system of claim 19, wherein the operations further comprise:
authenticating a user using credentials received from the user for both the workflow design-time and the workflow run-time, wherein the user accesses both the workflow design-time and the workflow run-time via the single graphical user interface.
